(19) United States
(12) Patent Application Publication
(10) Pub. No.: US 2022/0251852 A1
(43) Pub. Date: Aug. 11, 2022

(54) A BRICK SLIP PANEL AND A METHOD OF MANUFACTURE A BRICK SLIP PANEL

(71) Applicant: SKONTO CONCRETE CLADDING, SIA, Riga (LV)

(72) Inventor: Rihards RAVIS, Riga (LV)

(21) Appl. No.: 17/597,861

(22) PCT Filed: Aug. 23, 2019
(86) PCT No.: PCT/IB2019/057099

§ 371 Date: Jan. 27, 2022

(51) Int. Cl. E04F 13/08; E04F 13/14

(52) U.S. Cl. CPC E04F 13/0873; E04F 13/0862; E04F 13/147; E04F 13/0866

(57) ABSTRACT

Invention relates to brick slip panels and manufacture method of the brick slip panels to provide the appearance of a brick wall.

The present invention is a brick slip panel (14) adapted to be mounted on a building structure to form at least a portion of the outer walls of the building structure. The brick slip panel (14) comprises brick slips (1), wherein each brick slip (1) comprises a groove (7) is in a form of a dovetail. In the groves (7) of the brick slips (1), an anchoring members (8) are inserted. The brick slip panel (14) further comprises glass fibre reinforced concrete (GRC) panel (12), onto which the brick slips (1) are attached by means of the anchoring member (8) and a mortar (16) is arranged between the brick slips (1) covering a space between the adjacent brick slips (1).

### FIELD OF THE INVENTION

Invention relates to brick slip panels and manufacture method of the brick slip panels to provide the appearance of a brick wall. In particular, the invention relates to the attachment method of brick slips to the glass fibres reinforced concrete (GRC) panel.

### BACKGROUND OF THE INVENTION

International patent application publication No. WO 02/095162 discloses a panel comprising brick slips fixed to a backing layer. The backing layer comprises a foam layer and a metal frame disposed adjacent the foam layer. The metal frame comprises spaced, parallel, horizontal wires for supporting a row of brick slips. The foam layer comprises non-horizontal channels in the front face of the foam layer for accommodating the wires therein. The metal frame is fastenable to the support structure through the foam layer forming the brick slip panel.

International patent application publication No. WO 2014/175726 discloses a device, assembly and method for attaching brick slips forming brick slip wall. The device comprises a plate-like carrier, preferably consisting of heat-insulating material, the carrier serving as substrate for attaching rows of brick slips to the device, wherein the carrier comprises a groove (between two successive strips which are intended for the purpose of arranging rows of brick slips, wherein the width of the strips corresponds to a width of the brick slips to be arranged on the carrier.

### SUMMARY OF THE INVENTION

Aim of the invention is to design a brick slip panel with reliable and safe brick slip attachment to a concrete panel.

The present invention is a brick slip panel adapted to be mounted on a building structure to form at least a portion of the outer walls of the building structure. The brick slip panel comprises a glass fibre reinforced concrete (GRC) panel on which brick slips are attached. The brick slips are attached to the GRC panel not only by adhesion of rear or back surface of the brick slip to the GRC panel but also by anchoring members arranged therebetween.

Each brick slip has a front face, a rear face, an upper edge, a lower edge and side edges. Brick slips can either be manufactured by extrusion or cut from real bricks. The front face of the brick slip is visible when the brick slip is mounted to the GRC panel. The rear face of the brick slip comprises a groove running along entire length of the rear face. The groove may be in a form of a dovetail.

The grooves of the brick panel may be made in at least two embodiments. In one embodiment, the groove or the grooves are formed parallel to the upper edge and the lower edge of the brick slip, running along entire length of the rear face of the brick slip. In another embodiment, the groove or the grooves running along entire length of the rear face orthogonal to the upper edge and the lower edge of the brick slip.

The brick slip panel comprises anchoring members. Each anchoring member comprises a head and a protrusion. The anchoring member with its head is adapted to be inserted into the groove of the brick slip so that the head is housed within the groove. The anchoring member is inserted into the groove of the brick slips so that the anchoring member is restricted in its movement orthogonally to the back face of the brick slip, in result of which the brick slip may be safely attached to the GRC panel. The anchoring member may be selected from the group of a screw, a bolt, a pin, a clip and a flange. Preferably, the anchoring member is a screw because it is already made element, which may be incorporated into the dovetail groove with ease. In another embodiment, the anchoring element may has folded tip of the protrusion further increasing connection between the brick slip and the GRC panel via the anchoring member.

During manufacture of the brick slip panel, the GRC is injected or fills the grooves of the brick slips, which after curing provide mechanical connection between the brick slip and the GRC panel. Hence, the brick slip is secured to the GRC panel. Additionally, the brick slip is provided with the anchoring members that further increases attachment security of the brick slip to the GRC panel.

The brick slips are attached to the GRC panel by means of the anchoring member. In manufacture of the brick slip panel, the GRC is laid onto the pre-arranged brick slips so that the GRC covers the rear face of the brick slips, is arranged in the grooves of the brick slips and in the same grooves is arranged between the head of the anchoring member and the groove. The GRC fills the grooves of the brick slips as well as the space between the anchoring members and the grooves. The GRC is filled in such an amount that the anchoring members are within the panel without extending or protruding out of it. After curing a very strong brick slip panel is formed with reliable attachment of the brick slips to the GRC panel. Moreover, the GRC panel may cover a part of the upper edge, the lower edge and side edges of the brick slip.

Between the brick slips a mortar is arranged or laid. The mortar covers a space or gaps between the brick slips, mainly the space or gaps between the upper edge and the lower edge of the adjacent brick slips and the space or gaps between the side edges of adjacent brick slips.

In another embodiment, the brick slips may be incorporated not only on panels having one wall, but also on panels having side walls arranged in L-type or U-type configuration.

To manufacture aforementioned brick slip panel with incorporated anchoring members it requires certain manufacturing technology or method.

Method for manufacture of the brick slip panel characterized in that it comprises the following steps:
providing a support base with spacers, wherein the spacers are arranged so that the brick slips may be arranged resembling brick wall, wherein the spacers may be separate parts or integrals with the support base;
placing the brick slips with its front faces onto the support base in a such way that arranged brick slips represent a brick wall, wherein the anchoring members are positioned in the grooves of the brick slips and wherein the anchoring members may be positioned before or after the brick slips are placed onto the support base;
applying preferably by injection or pouring a mortar between the gaps of the brick slips so that the mortar covers the spacers; and
applying preferably by spraying or pouring the GRC onto the brick slips so that the brick slips, the mortar, the anchoring members are covered and GRC is also poured in the grooves of the brick slips forming a glass fibre reinforced concrete panel.

The mortar provided between the gaps of the brick slips serves for multiple purposes, Firstly, the mortar does not allow the GRC to reach the front face of the brick slips when it is poured onto the brick slips. Secondly, the mortar provides to the panel a brick wall look, because when in use the mortar is visible instead of GRC.

After applying and curing of the GRC, the GRC panel is formed and the same GRC panel is removed from the support base leaving also the spacers within the support base, in result of which the brick slip panel is formed. Poured GRC fills all grooves of the brick slips as well as all gaps between the anchoring members and the grooves of the brick slip. Hence, a reliable and strong attachment is formed between the GRC panel and the brick slips.

### BRIEF DESCRIPTION OF THE DRAWINGS

FIG. 1 is a perspective view of a brick slip 1 comprising a groove 7 in the rear face of the brick slip, wherein the groove runs an entire length of the brick slip 1 parallel to an upper edge 4 and a lower edge 5 of the brick slip 1.

FIG. 2 is a perspective view of a brick slip 1 comprising two grooves 7 in the rear face of the brick slip running parallel to each other, wherein both grooves 7 run an entire length of the brick slip 1 orthogonal to an upper edge 4 and a lower edge 5 of the brick slip 1.

FIG. 3 is a perspective view of a brick slip panel.

FIG. 4 is a part of section view (taken along lines A-A in FIG. 3) of a brick slip panel.

FIG. 5 is a close up view of the section view as shown in FIG. 4.

FIG. 6 is a section view of a brick slip panel during manufacturing when brick slips 1 are arranged onto a support base 20, spacers 21 are arranged between the brick slips 1 and a concrete panel 12 is formed by pouring a concrete onto the brick slips 1 and spacers 21.

FIG. 7 is a close up view of the section view as shown in FIG. 6.

FIG. 8 is a close up view of the section view as shown in FIGS. 4 and 5 to illustrate an anchoring member 8 with its head 9 into a groove 7 of a brick slip 1 and a GRC in the groove 7 and between the anchoring member 8 and side surfaces of the groove 7.

FIG. 9 is a perspective view of brick slip panel having U-type configuration and covered by brick slips 1.

FIG. 10 is a perspective view of brick slip panel having L-type configuration and covered by brick slips 1.

### DETAILED DESCRIPTION OF THE INVENTION

Before explaining the disclosed embodiment of the present invention in detail, it is to be understood that the invention is not limited in its application to the details of the particular arrangements shown, since the invention is capable of other embodiments. Also, the terminology used herein is for the purpose of description and not of limitation.

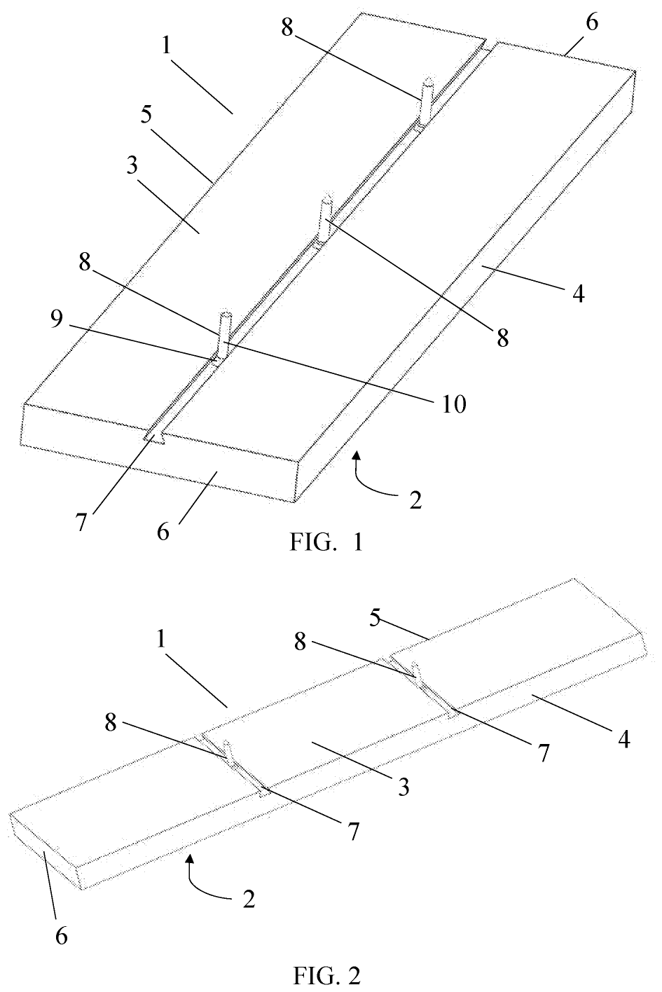

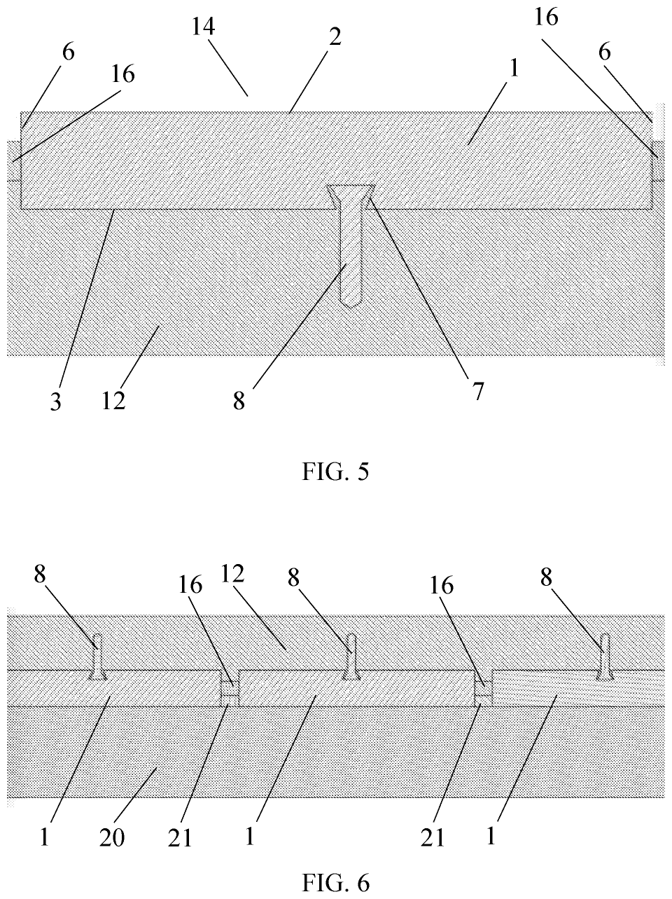

As shown in FIG. 1, a brick slip 1 has a front face 2, a rear face 3, an upper edge 4, a lower edge 5 and side edges 6. The rear face 3 of the brick slip 1 comprises a groove 7 running along entire length of the rear face 3 substantially parallel to the upper edge 4 and lower edge 5. The groove 7 is in a form of a dovetail so that an anchoring members 8, especially heads 9 of the anchoring members 8, are insertable into the groove 7. The groove 7 is formed so that the anchoring members 8 can in inserted into the groove by sliding the anchoring members 8 into the groove 7 from side edges 6 of the brick slip 1. The heads 9 of the anchoring members 8 are engaged with the groove 7 so that the anchoring members cannot be removed from the brick slip in directing orthogonal to the rear surface 3 of the brick slip 1. Protrusions 10 of the anchoring members 8 extends into the glass fibre reinforced concrete (GRC) panel 12. Accordingly, when a brick slip 1 with its anchoring members 8 is build-in or set in the GRC panel 12 (see FIGS. 4, 5 and 8), the brick slip 1 cannot fall down due to any external force, for example due to vibrations onto a building to which a brick slip panel 14 is attached.

As shown in FIG. 2, the brick slip 1 can have the grooves 7 substantially orthogonal to the upper edge 4 and lower edge 5 or parallel to the side edges 6.

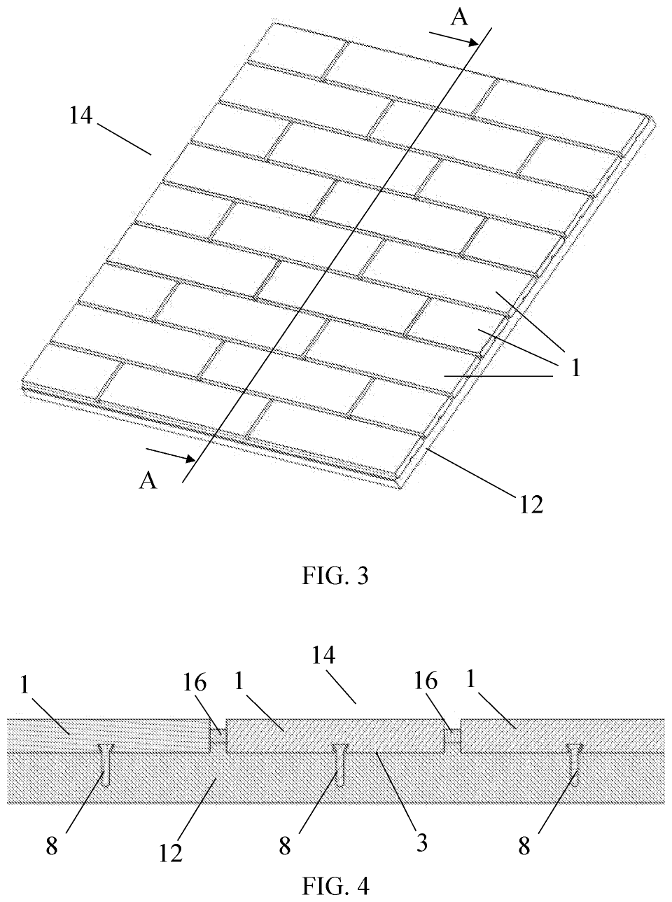

As shown in FIG. 3, a brick slip panel 14 comprises a GRC panel 12 onto which the brick slips 1 are attached.

As shown in FIGS. 4, 5 and 8 (a cross section of the brick slip panel 14), the brick slip panel 14 comprises the GRC panel 12 onto which the brick slips 1 are attached with its anchoring members 8 extending into the GRC panel 12. The brick slip panel 14 further comprises a mortar 16 arranged between the brick slips 1 so that the GRC panel 12 is covered from a front face of the brick slip panel 14 providing the brick slip panel 14 with a look resembling a real brick wall. A glass fibre reinforced concrete is also present in the grooves 7 of the brick slips 1, as well as between the anchoring members 8 and grooves 7, providing secure and solid attachment of brick slips 1 to the GRC panel 12.

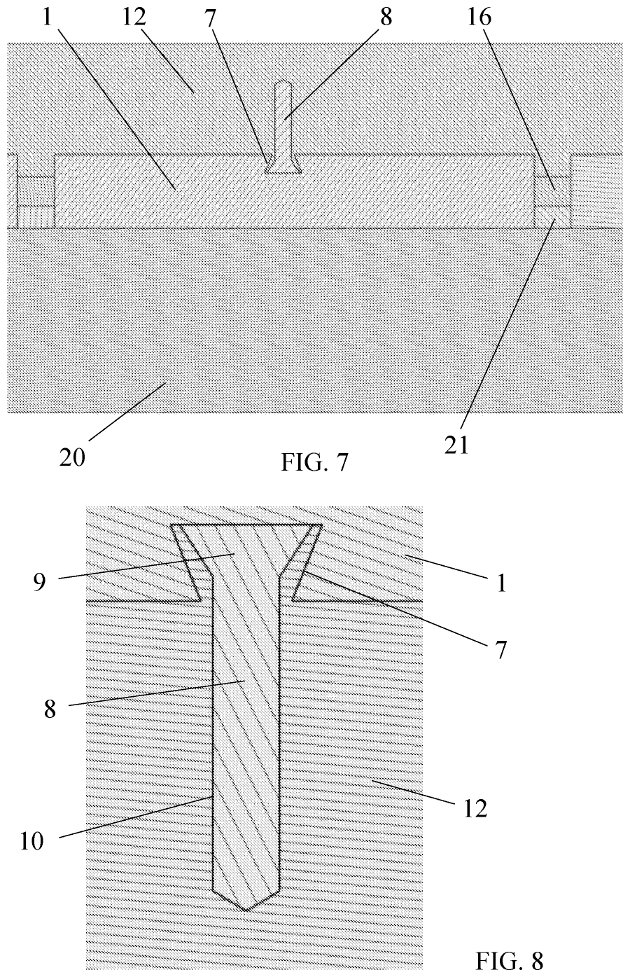

Aforementioned secure attachment of the brick slip 1 to the GRC panel 12 is achieved during manufacturing of the brick slip panel 14. FIGS. 6 and 7 is a section view of a brick slip panel 14 during manufacturing, when the brick slips 1 are arranged onto a support base 20 and spacers 21 are arranged between the brick slips 1. In another embodiment, the spacers 21 may be integral with the support base 20. The anchoring members 8 are arranged in the grooves 7. After the brick slips 1 and the anchoring members 8, a mortar 16 is injected between the brick slips 1 so that the mortar covers the spacers 21. After that a GRC is poured onto the brick slips 1 and the mortar 16. The GRC flows in also in the grooves 7 of the brick slips 1 as well as in gaps between the anchoring members 8 and the grooves 7. After curing, the GRC forms a GRC panel 12 that has strong link (attachment) between the anchoring members 8 and brick slips 1.

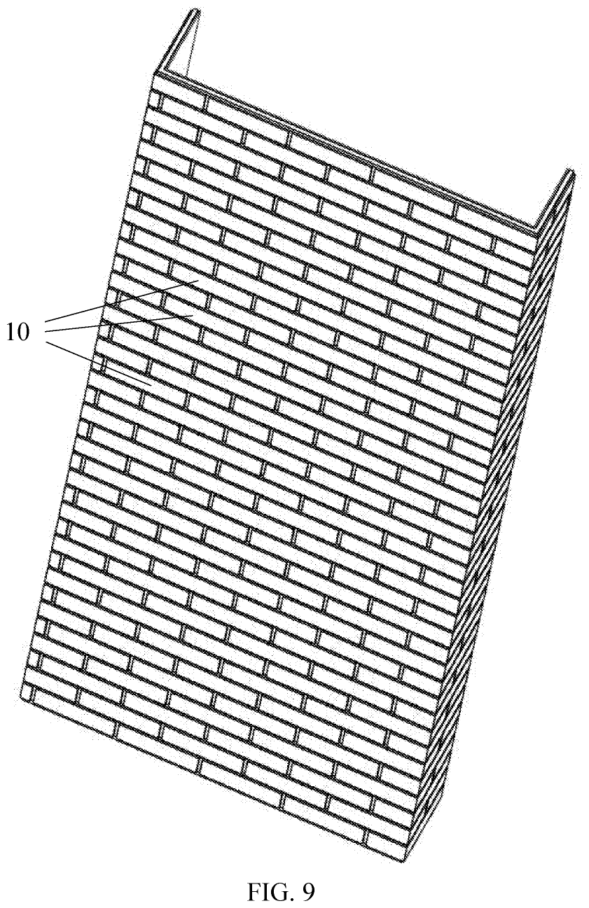

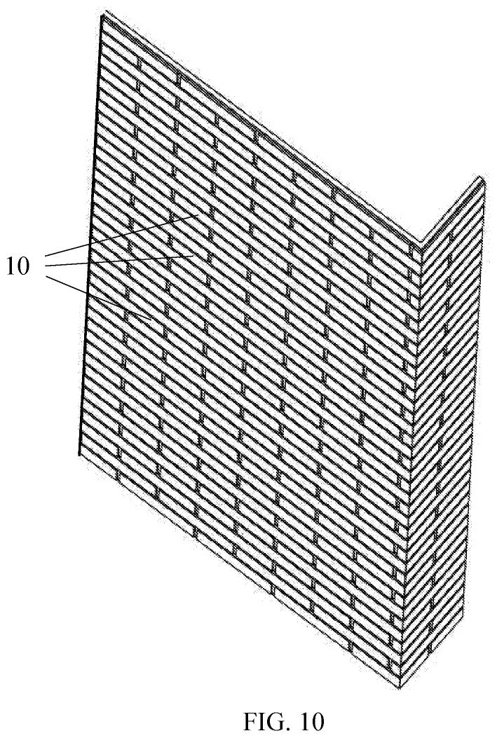

As shown in FIGS. 9 and 10 the brick slips 1 may be incorporated not only on panels having one wall, but also on panels having side walls arranged in L-type (FIG. 10) or U-type (FIG. 9) configuration.

The invention has been described with reference to various specific and illustrative embodiments and techniques. However, one skilled in the art will recognize that many variations and modifications may be made while remaining within the scope of the invention as defined in the appended claims.

### LIST OF REFERENCES

1—a brick slip;
2—a front face of a brick slip;
3—a rear face of a brick slip;
4—an upper edge of a brick slip;
5—a lower edge of a brick slip;
6—a side edge of a brick slip;
7—a groove;
8—an anchoring member;
9—a head of an anchoring member;
10—a protrusion of an anchoring member;
12—a glass fibre reinforced concrete (GRC) panel;
14—a brick slip panel;
16—a mortar;
20—a support base; and
21—a spacer.

1-9. (canceled)

10. A brick slip panel adapted to be mounted on a building structure to form at least a portion of the outer walls of the building structure comprising:
brick slips (1), wherein each brick slip (1) having a front face (2), a rear face (3), an upper edge (4), a lower edge (5) and side edges (6), wherein the rear face (3) of the brick slip (1) comprises a groove (7) running along entire length of the rear face (3), wherein the groove (7) is in a form of a dovetail;
an anchoring member (8) having a head (9) and a protrusion (10), wherein the anchoring member (8) with its head (9) is inserted into the groove (7);
a glass fibre reinforced concrete (GRC) panel (12), onto which the brick slips (1) are attached by means of the anchoring member (8), wherein the brick slips (1) are arranged on the concrete panel (12) so that the GRC panel (12) covers the rear face (3) of the brick slip (1), a part of the concrete panel (12) is arranged in the groove (7) and between the head (9) of the anchoring member (8) and the groove (7), and
a mortar (16) arranged between the brick slips (1) covering a space between the upper edge (4) of one brick slip (1) and the lower edge (5) of the adjacent brick slip (1) and a space between the side edges (6) of adjacent brick slips (1).

11. The brick slip panel according to claim 10, characterized in that the groove (7) running along entire length of the rear face (3) parallel to the upper edge (4) and the lower edge (2) of the brick slip (1).

12. The brick slip panel according to claim 10, characterized in that the groove (7) running along entire length of the rear face (3) orthogonal to the upper edge (4) and the lower edge (2) of the brick slip (1).

13. The brick slip panel according to claim 10, characterized in that the GRC panel (12) covers a part of the upper edge (4), the lower edge (2) and side edges (6) of the brick slip (1).

14. The brick slip panel according to claim 10, characterized in that the anchoring member (8) is selected from the group of a screw, a bolt, a pin, a clip and a flange.

15. Method for manufacture of the brick slip panel according to claim 10, characterized in that it comprises the following steps:
a) placing brick slips (1) with its front faces (2) onto a support base (20) in a such way that arranged brick slips (1) represent a brick wall;
b) arranging anchoring members (8) in the grooves (7) of the brick slips (1);
c) applying a mortar (16) between the gaps of the brick slips so that the mortar (16) covers the spacers (21);
d) applying a glass fibre reinforced concrete (GRC) onto the brick slips (1) so that the brick slips (1), the mortar (16), the anchoring members (8) are covered and GRC is also poured in the grooves (7) of the brick slips (1) forming a GRC panel (12);
e) curing of the GRC;
f) removing of cured GRC panel (12) from the support base (20) leaving also the spacers (21) within the support base (20), in result of which the brick slip panel (12) is formed.

16. Method according to claim 15 characterized in that the step b) is performed before the step a).

17. Method according to claim 15, characterized in that the mortar (16) is applied by injection.

18. Method according to claim 15, characterized in that the GRC is applied by spraying or pouring.
